(19) United States
(12) Patent Application Publication
(10) Pub. No.: US 2025/0158924 A1
(43) Pub. Date: May 15, 2025

(54) ANALYTICS BASED METHOD TO DECIDE EFFICIENT REDUNDANT TRANSMISSION MECHANISM FOR URLLC SERVICES

(71) Applicant: Huawei Technologies Co., Ltd., Shenzhen (CN)

(72) Inventors: Abbas Kiani, Vieanna, VA (US); Khosrow Tony Saboorian, Frisco, TX (US); Zhixian Xiang, Frisco, TX (US); Kaippallimalil Mathew John, Carrollton, TX (US)

(21) Appl. No.: 19/025,277

(22) Filed: Jan. 16, 2025

Related U.S. Application Data
(63) Continuation of application No. PCT/US2023/029597, filed on Aug. 7, 2023.
(60) Provisional application No. 63/396,487, filed on Aug. 9, 2022.

(51) Int. Cl. H04L 45/00; H04W 24/04; H04W 28/08

(52) U.S. Cl. CPC H04L 45/70; H04W 24/04; H04W 28/0925

(57) ABSTRACT

According to embodiments, a first network entity sends to a second network entity a request for enhanced analytics output parameters associated with a redundant transmission. The first network entity receives from the second network entity the enhanced analytics output parameters. The first network entity determines a mechanism for the redundant transmission based on the enhanced analytics output parameters.

### PRIORITY CLAIM AND CROSS-REFERENCE

This patent application is a continuation of International Application No. PCT/US2023/029597 filed on Aug. 7, 2023 and entitled “New Analytics Based Method to Decide Efficient Redundant Transmission Mechanism for URLLC Services,” which claims the benefit of U.S. Provisional Application No. 63/396,487, filed on Aug. 9, 2022 and entitled “New Analytics Based Method to Decide Efficient Redundant Transmission Mechanism for URLLC Services,” applications which are hereby incorporated by reference herein as if reproduced in their entireties.

### TECHNICAL FIELD

The present disclosure relates generally to generally to wireless communications, and in particular embodiments, to techniques and mechanisms for ultra-reliable low latency communications (URLLC) services.

### BACKGROUND

URLLC services are introduced to support 5G use cases such as autonomous driving, public safety, and remote surgery. End-to-end (E2E) latency and reliability are parameters used for URLLC services. User data packets should be successfully delivered within certain time constraints to satisfy the end user requirements. These parameters may be impacted by not only the network capability but also the network configurations. To satisfy the high reliability requirements of the URLLC services, in addition to support of redundant transmission at the transport layer, 3GPP TS 23.501 has specified two different mechanisms to support redundant transmission of these services including dual-connectivity-based end-to-end redundant user plane paths and support of redundant transmission on N3/N9 interfaces. In any case, user packets are duplicated and simultaneously transferred to the receiver via the two disjoint user plane paths. The redundant packets are then eliminated at the receiver side. Therefore, service failure can be avoided even in case the packet transmission via one path fails or exceeds the delay requirement.

The disjoint paths may be established via two disjoint protocol data unit (PDU) sessions (e.g., end to end) or one PDU session but via two separate N3/N9 tunnels. Based on the network scenario, the user equipment (UE), the next generation radio access network (NG-RAN), and the user plane function (UPF) may replicate packets or eliminate duplicated packets. For example, if duplication transmission is performed on N3/N9 interface, for each downlink packet of the quality of service (QOS) flow that the PDU session anchor (PSA) UPF receives from DN, the PSA UPF replicates the packet and assigns the same GTP-U sequence number to them for the redundant transmission. The NG-RAN eliminates the duplicated packets based on the general packet radio service (GPRS) tunneling protocol user plane (GTP-U) sequence number and then forwards the PDU to the UE. For each uplink packet of the QoS Flow that the NG-RAN receives from UE, the NG-RAN replicates the packet and assigns the same GTP-U sequence number to them for redundant transmission. The PSA UPF eliminates the duplicated packet based on the GTP-U sequence number accordingly.

### SUMMARY

Technical advantages are generally achieved, by embodiments of this disclosure which describe methods and apparatus for efficient redundant transmission mechanism for URLLC services.

According to embodiments, a first network entity sends to a second network entity a request for enhanced analytics output parameters associated with a redundant transmission. The first network entity receives from the second network entity the enhanced analytics output parameters. The first network entity determines a mechanism for the redundant transmission based on the enhanced analytics output parameters.

In some embodiments, the first network entity may include at least one of a policy control function (PCF) or a session management function (SMF). The second network entity may include a network data analytics function (NWDAF).

In some embodiments, the first network entity may determine whether to activate or deactivate the redundant transmission based on the enhanced analytics output parameters.

In some embodiments, after determining to activate the redundant transmission, the first network entity may determine whether to update User Equipment (UE) Route Selection Policy (URSP) rules for the redundant transmission based on the enhanced analytics output parameters. In some embodiments, after determining to update the URSP rules, the first network entity may update URSP rule information for the redundant transmission. The first network entity may send to a URSP rule policy making entity the URSP rule information. In some embodiments, the URSP rule policy making entity may include a PCF.

In some embodiments, the enhanced analytics output parameters may be for each path of a primary path and a secondary path of the redundant transmission.

In some embodiments, the enhanced analytics output parameters may be for each link of links for the redundant transmission. The links for the redundant transmission may include at least one radio access network (RAN) link and at least one N3 link.

In some embodiments, the enhanced analytics output parameters may be based on enhanced analytics input parameters. The enhanced analytics input parameters may include a RAN uplink (UL) or downlink (DL) packet delay.

In some embodiments, the enhanced analytics output parameters may include at least one of a predicted primary or secondary RAN path redundant transmission experience between a UE and a master or a secondary next generation (NG)-RAN, a predicted primary or secondary N3 tunnel path redundant transmission experience from an NG-RAN to a user plane function (UPF), or a list of one or more master or secondary NG-RAN nodes.

According to embodiments, a second network entity receives from a first network entity a request for enhanced analytics output parameters associated with a redundant transmission. The second network entity collects enhanced analytics input parameters associated with the redundant transmission. The second network entity sends to the first network entity, the enhanced analytics output parameters.

In some embodiments, the second network entity may collect the enhanced analytics input parameters from at least one of a policy control function (PCF), a session management function (SMF), a user plane function (UPF), an operations, administration, and management (OAM), or an access and mobility management function (AMF).

In some embodiments, the first network entity may include at least one of a policy control function (PCF) or a session management function (SMF). The second network entity may include a network data analytics function (NWDAF).

In some embodiments, the enhanced analytics output parameters may be for each path of a primary path and a secondary path of the redundant transmission.

In some embodiments, the enhanced analytics output parameters may be for each link of links for the redundant transmission. The links for the redundant transmission may include at least one radio access network (RAN) link and at least one N3 link.

In some embodiments, the second network entity may determine the enhanced analytics output parameters based on enhanced analytics input parameters. The enhanced analytics input parameters may include a RAN uplink (UL) or downlink (DL) packet delay.

In some embodiments, the enhanced analytics output parameters may include at least one of a predicted primary or secondary RAN path redundant transmission experience between a UE and a master or a secondary next generation (NG)-RAN, a predicted primary or secondary N3 tunnel path redundant transmission experience from an NG-RAN to a user plane function (UPF), or a list of one or more master or secondary NG-RAN nodes.

### BRIEF DESCRIPTION OF THE DRAWINGS

For a more complete understanding of the present disclosure, and the advantages thereof, reference is now made to the following descriptions taken in conjunction with the accompanying drawings, in which:

FIG. 1A illustrates an example communications system 100, according to some embodiments;

FIG. 1B shows an example network scenario for dual-connectivity-based end-to-end redundant user plane paths, according to some embodiments;

FIG. 2 shows an example network scenario for redundant transmission on two N3 tunnels, according to some embodiments;

FIG. 3 shows an example network scenario for redundant transmission on two N3 and N9 tunnels with two I-UPFs used, according to some embodiments;

FIG. 4A shows an example flow for interactions between 5G entities, according to some embodiments;

FIG. 4B shows an example flow for determining redundant transmission mechanism and corresponding URSP updates, according to some embodiments;

FIG. 5 is a flow diagram showing an example method of determining if and/or what redundant transmission mechanism is required, according to some embodiments;

FIG. 6 is a flow diagram showing an example method of determining if and/or what redundant transmission mechanism is required, according to some embodiments;

FIG. 7A illustrates a flow chart of a method performed by a first network entity, according to some embodiments;

FIG. 7B illustrates a flow chart of a method performed by a second network entity, according to some embodiments;

FIG. 8 illustrates an embodiment communication system;

FIGS. 9A and 9B illustrate example devices that may implement the methods and teachings according to this disclosure; and

FIG. 10 shows a block diagram of a computing system that may be used for implementing the devices and methods disclosed herein, according to some embodiments.

Corresponding numerals and symbols in the different figures generally refer to corresponding parts unless otherwise indicated. The figures are drawn to clearly illustrate the relevant aspects of the embodiments and are not necessarily drawn to scale.

### DETAILED DESCRIPTION OF THE EMBODIMENTS

The making and using of embodiments of this disclosure are discussed in detail below. It should be appreciated, however, that the concepts disclosed herein can be embodied in a wide variety of specific contexts, and that the specific embodiments discussed herein are merely illustrative and do not serve to limit the scope of the claims. Further, it should be understood that various changes, substitutions and alterations can be made herein without departing from the spirit and scope of this disclosure as defined by the appended claims.

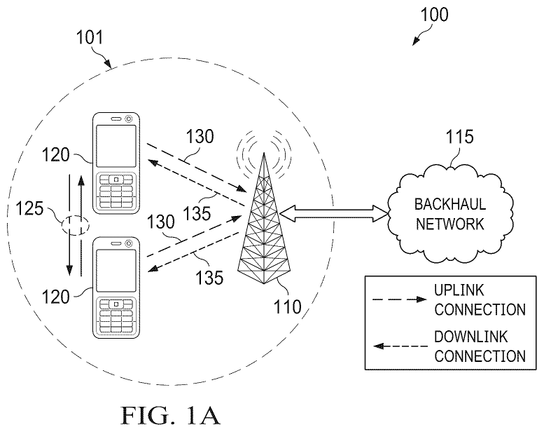

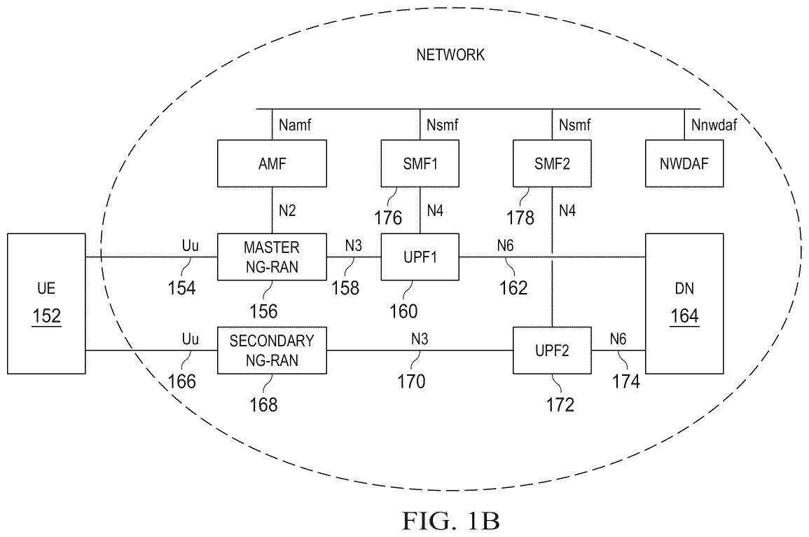

FIG. 1A illustrates an example communications system 100, according to embodiments. Communications system 100 includes an access node 110 serving user equipments (UEs) with coverage 101, such as UEs 120. In a first operating mode, communications to and from a UE passes through access node 110 with a coverage area 101. The access node 110 is connected to a backhaul network 115 for connecting to the internet, operations and management, and so forth. In a second operating mode, communications to and from a UE do not pass through access node 110, however, access node 110 typically allocates resources used by the UE to communicate when specific conditions are met. Communications between a pair of UEs 120 can use a sidelink connection (shown as two separate one-way connections 125). In FIG. 1A, the sideline communication is occurring between two UEs operating inside of coverage area 101. However, sidelink communications, in general, can occur when UEs 120 are both outside coverage area 101, both inside coverage area 101, or one inside and the other outside coverage area 101. Communication between a UE and access node pair occur over uni-directional communication links, where the communication links between the UE and the access node are referred to as uplinks 130, and the communication links between the access node and UE is referred to as downlinks 135.

Access nodes may also be commonly referred to as Node Bs, evolved Node Bs (eNBs), next generation (NG) Node Bs (gNBs), master eNBs (MeNBs), secondary eNBs (SeNBs), master gNBs (MgNBs), secondary gNBs (SgNBs), network controllers, control nodes, base stations, access points, transmission points (TPs), transmission-reception points (TRPs), cells, carriers, macro cells, femtocells, pico cells, and so on, while UEs may also be commonly referred to as mobile stations, mobiles, terminals, users, subscribers, stations, and the like. Access nodes may provide wireless access in accordance with one or more wireless communication protocols, e.g., the Third Generation Partnership Project (3GPP) long term evolution (LTE), LTE advanced (LTE-A), 5G, 5G LTE, 5G NR, sixth generation (6G), High Speed Packet Access (HSPA), the IEEE 802.11 family of standards, such as 802.11a/b/g/n/ac/ad/ax/ay/be, etc. While it is understood that communications systems may employ multiple access nodes capable of communicating with a number of UEs, only one access node and two UEs are illustrated for simplicity.

The network data analytics function (NWDAF) is part of the 5G core (5GC) and uses the mechanisms and interfaces specified for 5GC. The NWDAF is the 5G network analytics producer which may interact with different entities for different purposes. The NWDAF may perform data collection from other 5G network functions (NFs), application function (AF), and operations, administration, and management (OAM). The NWDAF may also retrieve information from data source(s) and provision on demand analytics to network analytics consumers such as other NFs, OAM, UE, and AF. 3GPP has specified functionalities at the NWDAF to perform model training and derive analytics. The NWDAF may include a Model Training logical function (MTLF) which trains Machine Learning (ML) models and exposes new training services (e.g. providing trained ML model). The NWDAF may also include the analytics logical function (AnLF) which performs inference, derives analytics information (e.g., derives statistics and/or predictions based on Analytics Consumer request), and exposes analytics service (e.g., Nnwdaf_AnalyticsSubscription or Nnwdaf_AnalyticsInfo).

To support 5G NFs to enable URLLC related network configurations based on 5G network AI/ML capabilities specifically at the NWDAF, 3GPP TS 23.288 has defined Analytics ID= “Redundant Transmission Experience” to be provided by the NWDAF and consumed by other NFs such as the session management function (SMF).

FIG. 1B shows an example network scenario for dual-connectivity-based end-to-end redundant user plane paths, according to some embodiments.

To support highly reliable URLLC services, the UE 152 may be allowed to set up two redundant PDU sessions over the 5G network with two disjoint user plane (UP) paths. For example, the first UP path may include the Uu interface 154, the master NG-RAN node(s) 156, the N3 tunnel 158, the UPF1 160, and the N6 tunnel 162 connected to the data network (DN) 164. The second UP path may include the Uu interface 166, the secondary NG-RAN node(s) 168, the N3 tunnel 170, the UPF2 172, and the N6 tunnel 174 connected to the DN 164. In other words, two independent UP paths via two instances of UPF 160 and 172 are set up which are connected to the same DN. In this case, the user's subscription information in unified data management (UDM) which is provided to the SMF (e.g., SMF1 176 or SMF2 178) may help to identify whether the UE 152 is allowed to have redundant PDU sessions. UE route selection policy (URSP) rules may be used to establish the two redundant PDU sessions and assign the duplicated traffic of the same UE 152 application to these sessions.

In case that the reliability of NG-RAN node, UPF, and other NFs are high enough to meet the URLLC reliability requirements of URLLC services but the reliability of N3/N9 interfaces may not be high enough, the redundant transmission mechanism may be performed only on N3 and/or N9 interfaces, where the N9 interface redundancy may be required if an intermediate UPF is used. Nevertheless, the redundant paths may be established via two independent N3/N9 associated with a single PDU session. The redundant transmission via two N3/N9 tunnels may be performed at QoS Flow granularity.

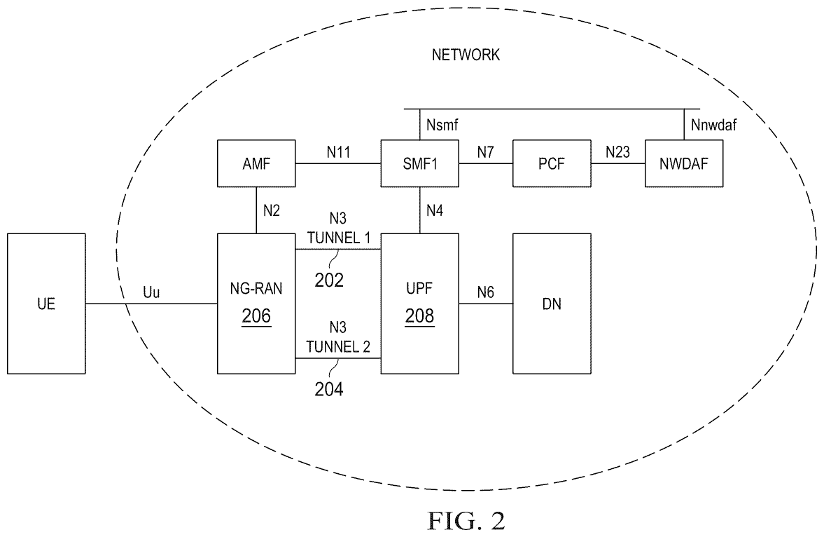

FIG. 2 shows an example network scenario for redundant transmission on two N3 tunnels (e.g., N3 tunnels 202 and 204 between the NG-RAN 206 and the UPF 208), according to some embodiments.

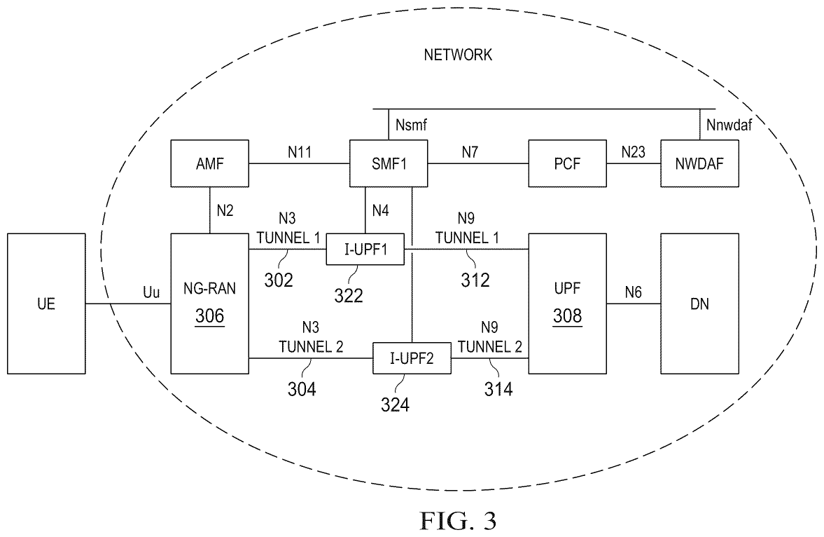

FIG. 3 shows an example network scenario for redundant transmission on two N3 and two N9 tunnels (e.g., N3 tunnels 302 and 304, and N9 tunnels 312 and 314 where two intermediate UPFs (I-UPFs) (e.g., I-UPFs 322 and 324) may be used between the NG-RAN node(s) 306 and the PSA UPF 308.

In addition to the UE authorization data, network capability information and/or operator configurations, Analytics ID= “Redundant Transmission Experience,” may be used by the SMF to determine whether redundant transmission can be performed, or the redundant transmission can be stopped if the redundant transmission has been activated. However, it is not defined how the network (e.g., 5G NFs) may leverage such analytics data to decide which redundant transmission option (from above options) may be needed. It is not either identified what information/parameters in the output analytics may be useful to determine which redundant transmission mechanism may be more efficient based on the network statistics/predictions.

The current solutions do not define or identify what NWDAF output analytics information may be used to choose a more reliable mechanism from the specified redundant transmission mechanisms. Although the existing solutions including the 3GPP suggest that the SMF may use Analytics ID= “Redundant Transmission Experience” to determine whether a redundant transmission may be performed or stopped, it is not specified how the SMF may make use of such analytics ID to decide which mechanism to be activated. Although the existing solutions including the 3GPP suggest URSP rules may be used to initiate a redundant transmission request at the UE, it is not yet specified how PCF may make use of Analytics ID= “Redundant Transmission Experience” to identify if and what URSP rules updates are required.

Embodiments of this disclosure describe technical solutions to enhance redundant transmission experience analytics with new input and output parameters such that the consumers of the Analytics ID (such as the SMF and/or policy control function (PCF)) may use it to determine a more reliable redundant transmission mechanism or accordingly update a redundant transmission option, for example, for a specific UE, a group of UEs, or a target area of interest. This disclosure further describes technical solutions including defining procedures for interactions between 5G NFs (including but not limited to NWDAF, PCF, SMF, and UPF, UE and/or OAM), in which the entities of the method may use enhanced analytics output data to determine an efficient redundant transmission mechanism based on the network performance statistics and/or predictions.

In addition to the new network experience parameters (e.g., the RAN latency), embodiments of this disclosure describe how to add new parameters in the output analytics to identify a list of current and/or predicted of master and secondary NG-RAN nodes. The NWDAF may calculate statistics of these parameters using UE Mobility information collected from the 5GC. The predicted values may also be calculated based on predicted UE location via leveraging output analytics of UE mobility predictions available in the NWDAF. These values may help to update URSP rules based on the predicted/current list of master/secondary NG-RAN nodes. Moreover, these parameters may help the decision for end-to-end redundant user plane paths in case that the NG-RAN realizes redundant user plane resources for the two PDU sessions with two NG-RAN nodes.

TABLE 4

| Information | Source | Description |
|---|---|---|
| >UL/DL packet | OAM | UL/DL packet drop rate measurement |
| drop GTP | | on GTP path on N3. |
| >UL/DL packet | UPF | End-to-End measurements from UE |
| delay GTP | | to UPF. |
| >> QoS monitoring | UPF/SMF | Indicator which shows SMF has sent |
| indicator | | QoS monitoring request. |
| >>UL/DL packet | UPF/SMF | RAN part of UL/DL packet delay |
| delay RAN | (see 1, 2, | measurement |
| | and 3 as | |
| | below) | |
| >UL/DL packet | OAM - | UL/DL packet delay measurement |
| delay GTP | | round trip on GTP path on N3. |

1: As specified in TS 23.501 clause 5.33.3, the NG-RAN initiates the RAN part of UL/DL packet delay measurement based on the QoS Monitoring request from SMF. NG-RAN reports the RAN part of UL/DL packet delay result to the PSA UPF in the UL data packet or dummy UL packet.
2: It is assumed UL/DL packet delay RAN includes the measurements for both primary and secondary paths. As specified in TS 23.501 clause 5.33.3, if the redundant transmission on N3/N9 interfaces is activated, the UPF and NG-RAN performs QoS monitoring for both UP paths. The UPF reports the packet delay of the two UP paths respectively to the SMF.

Table 4 shows example input data related to redundant transmission analytics, according to some embodiments. As shown in Table 4, this disclosure defines new input data parameters including QoS monitoring indicator and/or UL/DL packet RAN delay to be collected by the NWDAF from other NFs (including but not limited to the UPF and/or the SMF). QoS monitoring in 5G is designed to assist URLLC services where the SMF may activate the end-to-end UL/DL packet delay measurement between the UE and the PSA UPF for a QoS Flow during the PDU session establishment or modification procedure. The QoS monitoring indicator in Table 4 may identify whether QoS monitoring is activated in the SMF (e.g., a value of ‘o’ may indicate not activated while ‘1’ may indicate activated). The NWDAF may use new input data parameters to calculate statistics and/or predictions parameters related to redundant transmission experience of URLLC services. The description of each new parameter is provided in Table 4.

TABLE 5

| Information | Description |
|---|---|
| UE group ID or | Identifies a UE, any UE, or a group of UEs. |
| UE ID, any UE | |
| DNN | Data Network Name associated for URLLC service. |
| Spatial | Area where the Redundant Transmission Experience |
| validity | applies. |
| | If Area of Interest information was provided |
| | in the request or subscription, spatial validity |
| | should be the requested Area of Interest. |
| Time slot entry | List of time slots during the Analytics target |
| (1 . . . max) | period. |
| > Time slot start | Time slot start within the Analytics target period. |
| > Duration | Duration of the time slot (average and variance). |
| > Redundant | Redundant Transmission Experience value. |
| Transmission | |
| Experience | |
| >> Primary RAN | Transmission Experience value of primary |
| Path Redundant | RAN path. |
| Transmission | |
| Experience (UE | |
| to Master NG-RAN) | |
| >> Secondary | Transmission Experience value of secondary RAN |
| (Redundant) RAN | (redundant) path. |
| Path Redundant | NOTE: in case that the redundant transmission is |
| Transmission | established only on N3 or N3/N9, this value can |
| Experience (UE to | be N/A. In case of end to end redundant UP paths, |
| secondary | the UPF can report the packet delay of the two |
| NG-RAN) | UP paths respectively to the NWDAF. |
| >> Primary N3 | Transmission Experience value of primary |
| Tunnel Path | N3 tunnel. |
| Redundant | NOTE: In case of I-UPF, this value can include |
| Transmission | both N3 and N9 experience. |
| Experience | |
| (NG-RAN to UPF) | |
| >> Secondary N3 | Transmission Experience value of secondary |
| Tunnel Path | N3 tunnel. |
| Redundant | NOTE: In case of I-UPF, this value can include |
| Transmission | both N3 and N9 experience. |
| Experience | |
| (NG-RAN to UPF) | |
| >List of master | List of Master NG-RAN nodes identified based on |
| NG-RAN nodes | current UE location |
| >List of secondary | List of secondary NG-RAN nodes identified based |
| NG-RAN nodes | on current UE location. |
| | NOTE: In Case that the redundant transmission is |
| | established only on N3 or N3/N9, this value can |
| | be N/A. |
| > Ratio | Percentage on which UE, any UE, or UE group |
| | efficiently use the PDU session with redundant |
| | transmission. |

Table 5 shows example output statistics data related to redundant transmission analytics, according to some embodiments. As shown in Table 5, this disclosure also defines new statistics parameters including the Primary RAN Path Redundant Transmission Experience (the UE to the Master NG-RAN), the Secondary (Redundant) RAN Path Redundant Transmission Experience (the UE to the secondary NG-RAN), the Primary N3 Tunnel Path Redundant Transmission Experience (the NG-RAN to the UPF), the Secondary N3 Tunnel Path Redundant Transmission Experience (NG-RAN to UPF), and the list of master NG-RAN nodes and/or the list of secondary NG-RAN nodes. The description of each parameter is provided in the table. The experience values may be of type NUM (numerical). For example, the experience value may be the level of experience in a certain time period (e.g., there are five levels which are represented by 1, 2, 3, 4, or 5, where level 1 represents that the users are enduring bad experience while level 5 represents that the users' requirements are perfectly satisfied).

TABLE 6

| Information | Description |
|---|---|
| UE group ID or | Identifies a UE or, any UE, a group of UEs. |
| UE ID, any UE | |
| DNN | Data Network Name associated for URLLC service. |
| Spatial | Area where the estimated Redundant Transmission |
| validity | Experience applies. |
| | If Area of Interest information was provided |
| | in the request or subscription, spatial validity |
| | should be the requested Area of Interest. |
| Time slot entry | List of predicted time slots. |
| (1 . . . max) | |
| >Time slot start | Time slot start time within the Analytics |
| | target period. |
| > Duration | Duration of the time slot. |
| > Redundant | Predicted Redundant Transmission Experience |
| Transmission | value during the Analytics target period. |
| Experience | |
| >> Primary RAN | Predicted Transmission Experience value of primary |
| Path Redundant | RAN path during the Analytics target period. |
| Transmission | |
| Experience (UE | |
| to Master | |
| NG-RAN) | |
| >> Secondary | Predicted Transmission Experience value of |
| (Redundant) RAN | secondary RAN (redundant) path during the |
| Path Redundant | Analytics target period. |
| Transmission | |
| Experience (UE | |
| to secondary | |
| NG-RAN) | |
| >> Primary N3 | Predicted Transmission Experience value of primary |
| Tunnel Path | N3 tunnel during the analytics target period. |
| Redundant | NOTE: In case of I-UPF, this value includes |
| Transmission | both N3 and N9 experience. |
| Experience | |
| (NG-RAN to UPF) | |
| >> Secondary N3 | Predicted Transmission Experience value of |
| Tunnel Path | secondary N3 tunnel during the analytics period. |
| Redundant | NOTE: In case of I-UPF, this value includes |
| Transmission | both N3 and N9 experience. |
| Experience | |
| (NG-RAN to UPF) | |
| >List of master | List of Master NG-RAN nodes identified based |
| NG-RAN nodes | on predicted UE location during the analytics |
| | period. |
| >List of secondary | List of Secondary NG-RAN nodes identified based |
| NG-RAN nodes | on predicted UE location during the analytics |
| | period. |
| > Ratio | Percentage on which the UE, any UE, or UE |
| | group may efficiently use the PDU session |
| | with redundant transmission. |
| > Confidence | Confidence of this prediction. |

Table 6 shows example output predictions data related to redundant transmission analytics, according to some embodiments. As shown in Table 6, this disclosure further defines new predictions parameters including the Primary RAN Path Redundant Transmission Experience (the UE to the Master NG-RAN), the Secondary (Redundant) RAN Path Redundant Transmission Experience (the UE to the secondary NG-RAN), the Primary N3 tunnel Path Redundant Transmission Experience (NG-RAN to UPF), the Secondary N3 Tunnel Path Redundant Transmission Experience (NG-RAN to UPF), and the list of master NG-RAN nodes and/or List of secondary NG-RAN nodes. The description of each parameter is provided in Table 6. The NWDAF AnLF and MTLF functionalities may be used to generate the new output parameters. Note that the values listed in Table 5 may indicate the current statistics while the values listed in Table 6 may indicate predicted and/or future values.

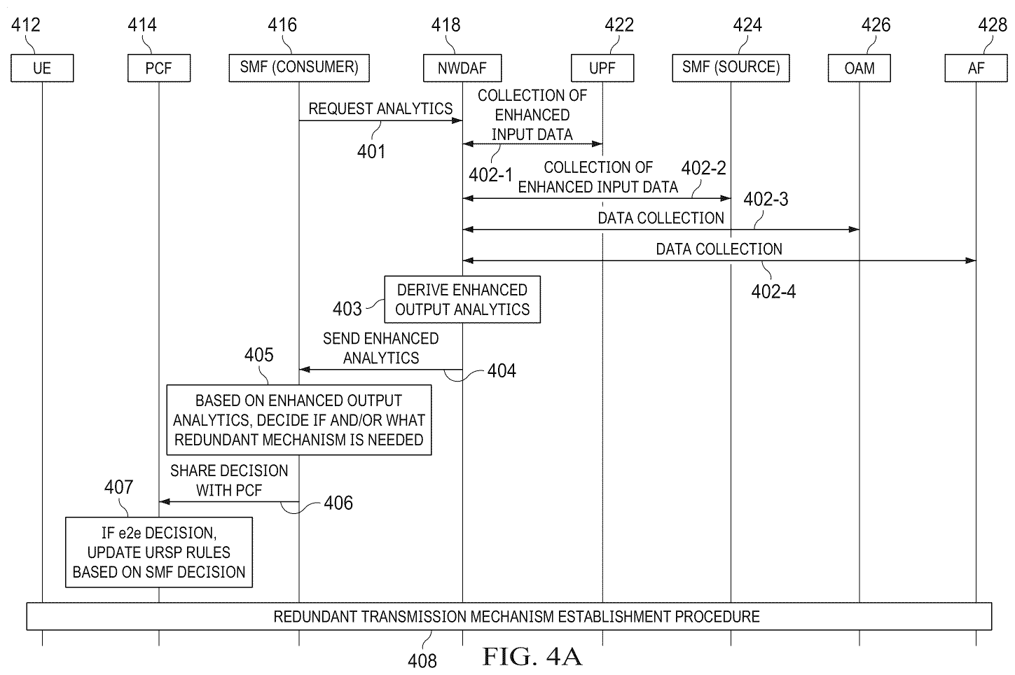

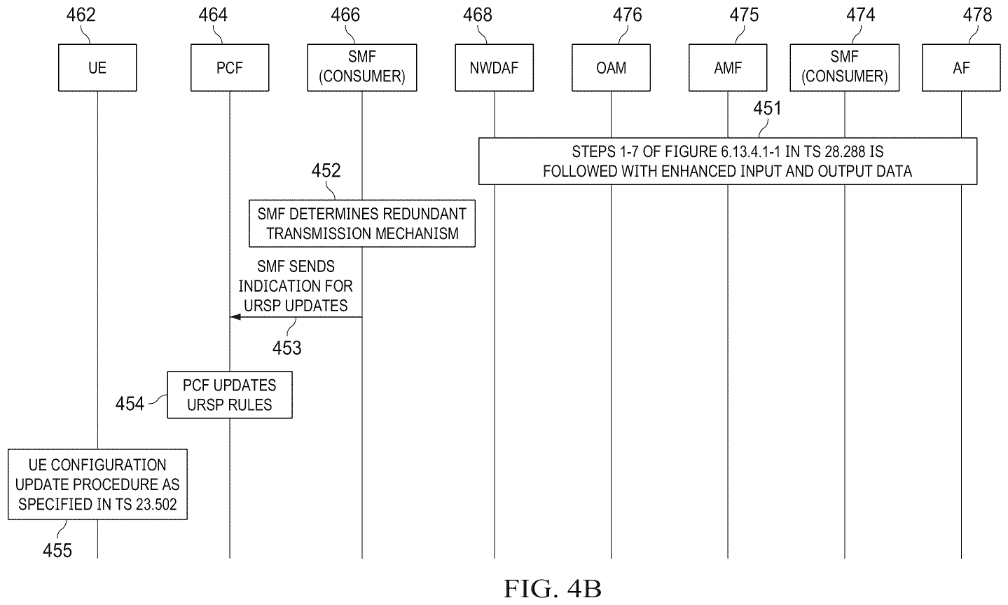

FIG. 4A shows an example flow for interactions between 5G NFs, AF, OAM, and/or UE to perform the technical solutions of this disclosure, according to some embodiments. 3GPP standardized subscribe interfaces, notify interfaces and/or a modified version of them may be used here at each operation of interactions between each two entities. As shown in FIG. 4A, at the operation 401, the SMF 416 may request the NWDAF 418 for the enhanced output analytics for redundant transmission experience including, for example, parameters listed in Table 5 and/or Table 6. The SMF 416 may indicate analytics filter information such as an area of interest in the request and the NWDAF 418 may provide the analytics according to the indicated analytics filter. At operations 402-1, 402-2, 402-3, and/or 402-4, the NWDAF 418 may perform input data collection from the SMF 424, the OAM 426, and/or the AF 428, respectively. The collected data may include, for example, the enhanced input data parameters of Table 4. At the operation 403, the NWDAF 418 may derive enhanced output analytics. The NWDAF 418 may send enhanced analytics data to the SMF 416 and/or any other consumer at the operation 404. In some embodiments, an SMF may play role of source when providing input data (e.g., the information of Table 4) to the NWDAF 418 and may also play role of analytics consumer when receiving output analytics from the NWDAF 418 (e.g., the information of Table 5 and/or Table 6). So, the SMF 416 and the SMF 424 may be the same SMF. For example, Nnwdaf_AnalyticsInfo_Response/Nnwdaf_AnalyticsSubscription_Notify may be used to expose Analytics information to the SMF and/or

Nsmf_EventExposure_Subscribe/Nsmf_EventExposure_Notify may be used to provide input data from the SMF to NWDAF 418.

At the operation 405, the SMF 416 may determine if and/or what redundant mechanism may be needed using enhanced analytics data. SMF may share its decision information with the PCF 414 at the operation 406, and the PCF 414 may accordingly decide to update URSP rules per received decision information at the operation 407. At the operation 408, existing 3GPP procedures and/or a modified version of them may be followed to establish redundant transmission PDU sessions based on the SMF decision information and/or PCF URSP rules. The NWDAF 418 may be modified to collect enhanced input data and provide enhanced output analytics. The SMF 416 may also be modified to support collecting new output analytics parameters from the NWDAF 416 and utilize them when deciding what redundant transmission mechanism should be performed. The PCF 414 may be modified to support handling the SMF decision information and utilize it in URSP rules related to dual-connectivity-based end-to-end redundant user plane paths.

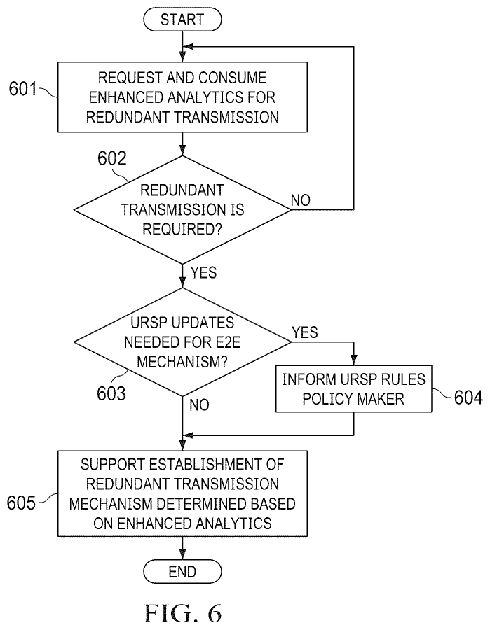

FIG. 4B shows an example flow for determining redundant transmission mechanism and corresponding URSP updates, according to some embodiments. At the operation 451 of FIG. 4B, Steps 1-7 of FIG. 6.13.4.1-1 in TS 23.288 may be reused where the NWDAF 468 may collect the enhanced input data from the SMF 474 and generate the enhanced output data.

At the operation 452, the SMF 466 determines if and what redundant mechanism is needed based on the enhanced output analytics. The SMF 466 may use the enhanced analytics parameters (statistics/predictions) including primary N3 tunnel redundant transmission experience and secondary N3 tunnel redundant transmission experience to determine whether redundant N3/N9 tunnels are required. The SMF 466 may further use the RAN related enhanced parameters including the primary RAN path redundant transmission experience, the secondary RAN path redundant transmission experience, the list of master NG-RAN node(s), and the list of secondary NG-RAN node(s) to determine whether redundant transmission between the UE 62 and the NG-RAN is required and what NG-RAN node(s) should be realized to establish the redundant sessions.

At the operation 453, the SMF 466 sends indication to the PCF 464 for URSP rules update according to the determined redundant mechanism.

At the operation 454, the PCF 464 updates the URSP rules based on the SMF information regarding the determined redundant transmission mechanism. Note that in the operation 454, the PCF 464 may also use other analytics IDs such as Analytic ID=“DN performance” or Analytic ID=“Load Level Information” to determine a better data network name (DNN) or slice instance for the redundant transmission mechanism.

At the operation 455, the UE configuration update procedure as specified in TS 23.502 is followed.

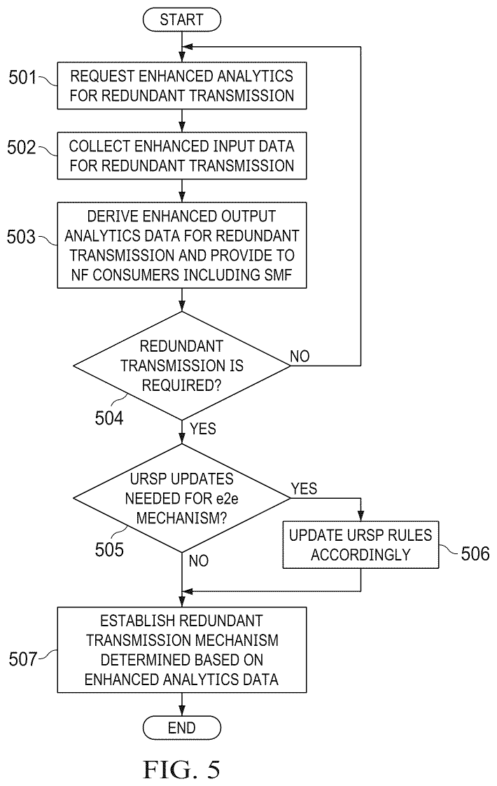

FIG. 5 is a flow diagram showing an example method of determining if and/or what redundant transmission mechanism is required, according to some embodiments. As shown in FIG. 5, at the operation 501, the analytics consumer (e.g., the SMF) may request the enhanced analytics (e.g., analytics with parameters in Table 5 and/or Table 6) from the analytics provider (e.g., the NWDAF). The analytics consumer may indicate analytics filter information such as an area of interest in the request. At the operation 502, the analytics provider may collect the enhanced input data (e.g., parameters in Table 4) from associated sources (e.g., SMF, OAM, and/or the like, etc.). At the operation 503, the analytics provider may derive the enhanced analytics and share with the analytics consumer. At the operation 504, it is determined whether redundant transmission is required. In case of requiring redundant transmission, at the operation 505, it is further determined based on the determined redundant mechanism whether URSP rules update is required. In case of requiring URSP rules update, at the operation 506, the URSP rules policy maker (e.g., the PCF) may update URSP rules accordingly. At the operation 507, PDU sessions for the determined redundant transmission mechanism may be established by network.

FIG. 6 is a flow diagram showing an example method to be performed at a network analytics consumer (e.g., the SMF) to determine if and/or what redundant transmission mechanism is required, according to some embodiments. As shown in FIG. 6, at the operation 601, the analytics consumer may request and/or consume the enhanced analytics (e.g., analytics with parameters in Table 5 and/or Table 6) from the analytics provider (e.g., the NWDAF). At the operation 602, it is determined whether redundant transmission is required. In case of requiring redundant transmission, at the operation 603, it is further determined based on the determined redundant mechanism whether URSP rules update is required. In case of requiring URSP rules update, at the operation 504, the analytics consumer may inform the URSP rules policy maker (e.g., the PCF). At the operation 505, the analytics consumer may support the establishment of PDU sessions for the determined redundant transmission mechanism.

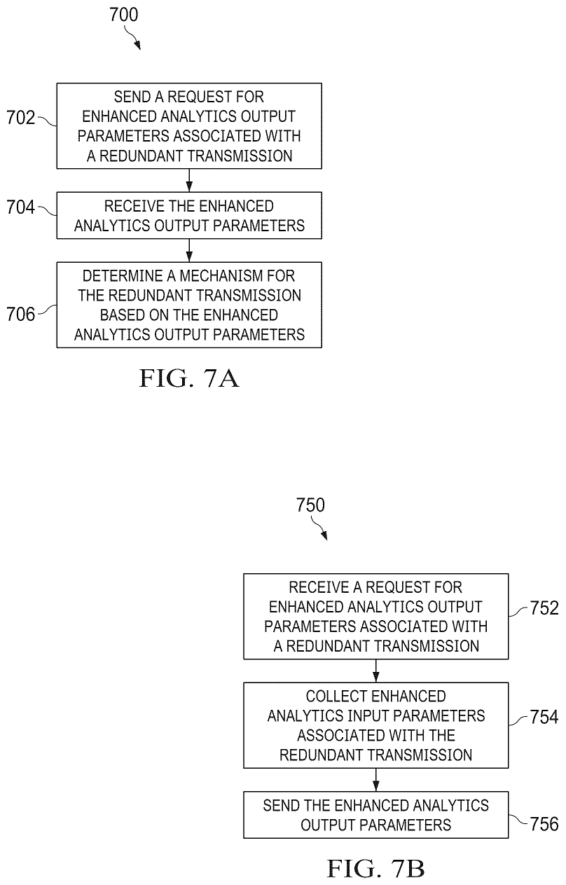

FIG. 7A illustrates a flow chart of a method 700 performed by a first network entity, according to some embodiments. The first network entity may include computer-readable code or instructions executing on one or more processors of the first network entity. Coding of the software for carrying out or performing the method 700 is well within the scope of a person of ordinary skill in the art having regard to the present disclosure. The method 700 may include additional or fewer operations than those shown and described and may be carried out or performed in a different order. Computer-readable code or instructions of the software executable by the one or more processors may be stored on a non-transitory computer-readable medium, such as for example, the memory of the first network entity.

The method 700 starts at the operation 702, wherein the first network entity sends to a second network entity a request for enhanced analytics output parameters associated with a redundant transmission. At the operation 704, the first network entity receives from the second network entity the enhanced analytics output parameters. At the operation 706, the first network entity determines a mechanism for the redundant transmission based on the enhanced analytics output parameters.

The first network entity is a network node, a network component, or a network module in a core network, such as a 5G New Radio (NR) core network, a sixth-generation (6G) wireless core network, or a next generation wireless core network. In some embodiments, the first network entity may include at least one of a policy control function (PCF) or a session management function (SMF) in a core network. The second network entity may include a network data analytics function (NWDAF) or any other network node that provides network data analytics.

In some embodiments, the first network entity may determine whether to activate or deactivate the redundant transmission based on the enhanced analytics output parameters.

In some embodiments, after determining to activate the redundant transmission, the first network entity may determine whether to update User Equipment (UE) Route Selection Policy (URSP) rule(s) for the redundant transmission based on the enhanced analytics output parameters. In some embodiments, after determining to update the URSP rules, the first network entity may update URSP rule information for the redundant transmission. The first network entity may send to a URSP rule policy making entity the URSP rule information. In some embodiments, the URSP rule policy making entity may include a PCF.

In some embodiments, the enhanced analytics output parameters may be for each path of a primary path and a secondary path of the redundant transmission.

In some embodiments, the enhanced analytics output parameters may be for each link of links for the redundant transmission. The links for the redundant transmission may include at least one radio access network (RAN) link and at least one N3 link.

In some embodiments, the enhanced analytics output parameters may be based on enhanced analytics input parameters. The enhanced analytics input parameters may include a RAN uplink (UL) or downlink (DL) packet delay.

In some embodiments, the enhanced analytics output parameters may include at least one of a predicted primary or secondary RAN path redundant transmission experience between a UE and a master or a secondary next generation (NG)-RAN, a predicted primary or secondary N3 tunnel path redundant transmission experience from an NG-RAN to a user plane function (UPF), or a list of one or more master or secondary NG-RAN nodes.

FIG. 7B illustrates a flow chart of a method 750 performed by a second network entity, according to some embodiments. The second network entity may include computer-readable code or instructions executing on one or more processors of the second network entity. Coding of the software for carrying out or performing the method 750 is well within the scope of a person of ordinary skill in the art having regard to the present disclosure. The method 750 may include additional or fewer operations than those shown and described and may be carried out or performed in a different order. Computer-readable code or instructions of the software executable by the one or more processors may be stored on a non-transitory computer-readable medium, such as for example, the memory of the second network entity.

The method 750 starts at the operation 752, wherein the second network entity receives from a first network entity a request for enhanced analytics output parameters associated with a redundant transmission. At the operation 754, the second network entity collects enhanced analytics input parameters associated with the redundant transmission. At the operation 756, the second network entity sends to the first network entity, the enhanced analytics output parameters.

In some embodiments, the second network entity may collect the enhanced analytics input parameters from at least one of a policy control function (PCF), a session management function (SMF), a user plane function (UPF), an operations, administration, and management (OAM), or an access and mobility management function (AMF).

In some embodiments, the first network entity may include at least one of a policy control function (PCF) or a session management function (SMF). The second network entity may include a network data analytics function (NWDAF).

In some embodiments, the enhanced analytics output parameters may be for each path of a primary path and a secondary path of the redundant transmission.

In some embodiments, the enhanced analytics output parameters may be for each link of links for the redundant transmission. The links for the redundant transmission may include at least one radio access network (RAN) link and at least one N3 link.

In some embodiments, the second network entity may determine the enhanced analytics output parameters based on enhanced analytics input parameters. The enhanced analytics input parameters may include a RAN uplink (UL) or downlink (DL) packet delay.

In some embodiments, the enhanced analytics output parameters may include at least one of a predicted primary or secondary RAN path redundant transmission experience between a UE and a master or a secondary next generation (NG)-RAN, a predicted primary or secondary N3 tunnel path redundant transmission experience from an NG-RAN to a user plane function (UPF), or a list of one or more master or secondary NG-RAN nodes.

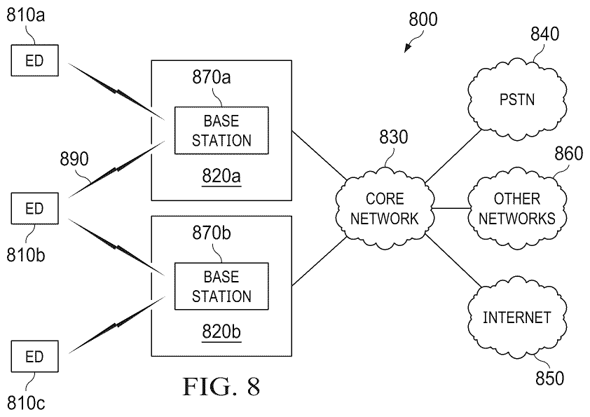

FIG. 8 illustrates an example communication system 800. In general, the system 800 enables multiple wireless or wired users to transmit and receive data and other content. The system 800 may implement one or more channel access methods, such as code division multiple access (CDMA), time division multiple access (TDMA), frequency division multiple access (FDMA), orthogonal FDMA (OFDMA), single-carrier FDMA (SC-FDMA), or non-orthogonal multiple access (NOMA).

In this example, the communication system 800 includes electronic devices (ED) 810a-810c, radio access networks (RANs) 820a-820b, a core network 830, a public switched telephone network (PSTN) 840, the Internet 850, and other networks 860. While certain numbers of these components or elements are shown in FIG. 8, any number of these components or elements may be included in the system 800.

The EDs 810a-810c are configured to operate or communicate in the system 800. For example, the EDs 810a-810c are configured to transmit or receive via wireless or wired communication channels. Each ED 810a-810c represents any suitable end user device and may include such devices (or may be referred to) as a user equipment or device (UE), wireless transmit or receive unit (WTRU), mobile station, fixed or mobile subscriber unit, cellular telephone, personal digital assistant (PDA), smartphone, laptop, computer, touchpad, wireless sensor, or consumer electronics device.

The RANs 820a-820b here include base stations 870a-870b, respectively. Each base station 870a-870b is configured to wirelessly interface with one or more of the EDs 810a-810c to enable access to the core network 830, the PSTN 840, the Internet 850, or the other networks 860. For example, the base stations 870a-870b may include (or be) one or more of several well-known devices, such as a base transceiver station (BTS), a Node-B (NodeB), an evolved NodeB (eNB), a Next Generation (NG) NodeB (gNB), a gNB centralized unit (gNB-CU), a gNB distributed unit (gNB-DU), a Home NodeB, a Home eNodeB, a site controller, an access point (AP), or a wireless router. The EDs 810a-810c are configured to interface and communicate with the Internet 850 and may access the core network 830, the PSTN 840, or the other networks 860.

In the embodiment shown in FIG. 8, the base station 870a forms part of the RAN 820a, which may include other base stations, elements, or devices. Also, the base station 870b forms part of the RAN 820b, which may include other base stations, elements, or devices. Each base station 870a-870b operates to transmit or receive wireless signals within a particular geographic region or area, sometimes referred to as a “cell.” In some embodiments, multiple-input multiple-output (MIMO) technology may be employed having multiple transceivers for each cell.

The base stations 870a-870b communicate with one or more of the EDs 810a-810c over one or more air interfaces 890 using wireless communication links. The air interfaces 890 may utilize any suitable radio access technology.

It is contemplated that the system 800 may use multiple channel access functionality, including such schemes as described above. In particular embodiments, the base stations and EDs implement 5G New Radio (NR), LTE, LTE-A, or LTE-B. Of course, other multiple access schemes and wireless protocols may be utilized.

The RANs 820a-820b are in communication with the core network 830 to provide the EDs 810a-810c with voice, data, application, Voice over Internet Protocol (VOIP), or other services. Understandably, the RANs 820a-820b or the core network 830 may be in direct or indirect communication with one or more other RANs (not shown). The core network 830 may also serve as a gateway access for other networks (such as the PSTN 840, the Internet 850, and the other networks 860). In addition, some or all of the EDs 810a-810c may include functionality for communicating with different wireless networks over different wireless links using different wireless technologies or protocols. Instead of wireless communication (or in addition thereto), the EDs may communicate via wired communication channels to a service provider or switch (not shown), and to the Internet 850.

Although FIG. 8 illustrates one example of a communication system, various changes may be made to FIG. 8. For example, the communication system 800 could include any number of EDs, base stations, networks, or other components in any suitable configuration.

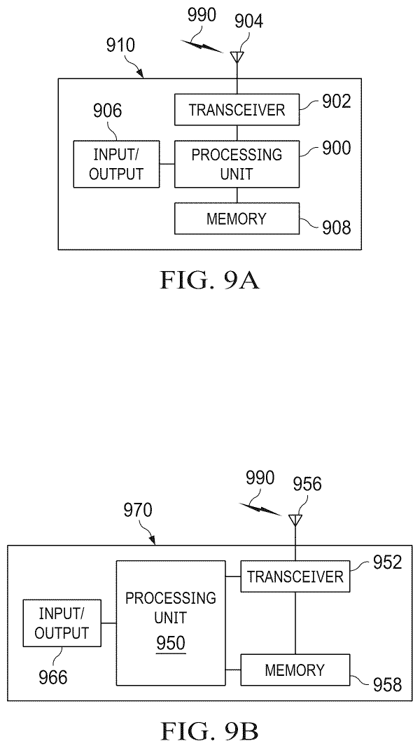

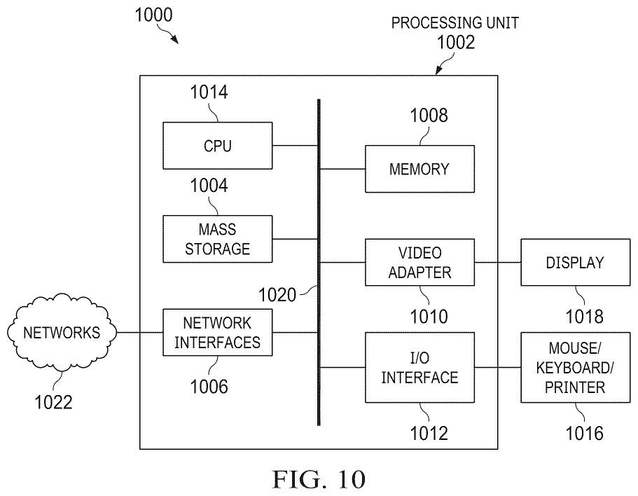

FIGS. 9A and 9B illustrate example devices that may implement the methods and teachings according to this disclosure. In particular, FIG. 9A illustrates an example ED 910, and FIG. 9B illustrates an example base station 970. These components could be used in the system 800 or in any other suitable system.

As shown in FIG. 9A, the ED 910 includes at least one processing unit 900. The processing unit 900 implements various processing operations of the ED 910. For example, the processing unit 900 could perform signal coding, data processing, power control, input/output processing, or any other functionality enabling the ED 910 to operate in the system 800. The processing unit 900 also supports the methods and teachings described in more detail above. Each processing unit 900 includes any suitable processing or computing device configured to perform one or more operations. Each processing unit 900 could, for example, include a microprocessor, microcontroller, digital signal processor, field programmable gate array, or application specific integrated circuit.

The ED 910 also includes at least one transceiver 902. The transceiver 902 is configured to modulate data or other content for transmission by at least one antenna or NIC (Network Interface Controller) 904. The transceiver 902 is also configured to demodulate data or other content received by the at least one antenna 904. Each transceiver 902 includes any suitable structure for generating signals for wireless or wired transmission or processing signals received wirelessly or by wire. Each antenna 904 includes any suitable structure for transmitting or receiving wireless or wired signals. One or multiple transceivers 902 could be used in the ED 910, and one or multiple antennas 904 could be used in the ED 910. Although shown as a single functional unit, a transceiver 902 could also be implemented using at least one transmitter and at least one separate receiver.

The ED 910 further includes one or more input/output devices 906 or interfaces (such as a wired interface to the Internet 850). The input/output devices 906 facilitate interaction with a user or other devices (network communications) in the network. Each input/output device 906 includes any suitable structure for providing information to or receiving information from a user, such as a speaker, microphone, keypad, keyboard, display, or touch screen, including network interface communications.

In addition, the ED 910 includes at least one memory 908. The memory 908 stores instructions and data used, generated, or collected by the ED 910. For example, the memory 908 could store software or firmware instructions executed by the processing unit(s) 900 and data used to reduce or eliminate interference in incoming signals. Each memory 908 includes any suitable volatile or non-volatile storage and retrieval device(s). Any suitable type of memory may be used, such as random access memory (RAM), read only memory (ROM), hard disk, optical disc, subscriber identity module (SIM) card, memory stick, secure digital (SD) memory card, and the like.

As shown in FIG. 9B, the base station 970 includes at least one processing unit 950, at least one transceiver 952, which includes functionality for a transmitter and a receiver, one or more antennas 956, at least one memory 958, and one or more input/output devices or interfaces 966. A scheduler, which would be understood by one skilled in the art, is coupled to the processing unit 950. The scheduler could be included within or operated separately from the base station 970. The processing unit 950 implements various processing operations of the base station 970, such as signal coding, data processing, power control, input/output processing, or any other functionality. The processing unit 950 can also support the methods and teachings described in more detail above. Each processing unit 950 includes any suitable processing or computing device configured to perform one or more operations. Each processing unit 950 could, for example, include a microprocessor, microcontroller, digital signal processor, field programmable gate array, or application specific integrated circuit.

Each transceiver 952 includes any suitable structure for generating signals for wireless or wired transmission to one or more EDs or other devices. Each transceiver 952 further includes any suitable structure for processing signals received wirelessly or by wire from one or more EDs or other devices. Although shown combined as a transceiver 952, a transmitter and a receiver could be separate components. Each antenna 956 includes any suitable structure for transmitting or receiving wireless or wired signals. While a common antenna 956 is shown here as being coupled to the transceiver 952, one or more antennas 956 could be coupled to the transceiver(s) 952, allowing separate antennas 956 to be coupled to the transmitter and the receiver if equipped as separate components. Each memory 958 includes any suitable volatile or non-volatile storage and retrieval device(s). Each input/output device 966 facilitates interaction with a user or other devices (network communications) in the network. Each input/output device 966 includes any suitable structure for providing information to or receiving/providing information from a user, including network interface communications.

FIG. 10 is a block diagram of a computing system 1000 that may be used for implementing the devices and methods disclosed herein. For example, the computing system can be any entity of UE, access network (AN), mobility management (MM), session management (SM), user plane gateway (UPGW), or access stratum (AS). Specific devices may utilize all of the components shown or only a subset of the components, and levels of integration may vary from device to device. Furthermore, a device may contain multiple instances of a component, such as multiple processing units, processors, memories, transmitters, receivers, etc. The computing system 1000 includes a processing unit 1002. The processing unit includes a central processing unit (CPU) 1014, memory 1008, and may further include a mass storage device 1004, a video adapter 1010, and an I/O interface 1012 connected to a bus 1020.

The bus 1020 may be one or more of any type of several bus architectures including a memory bus or memory controller, a peripheral bus, or a video bus. The CPU 1014 may comprise any type of electronic data processor. The memory 1008 may comprise any type of non-transitory system memory such as static random access memory (SRAM), dynamic random access memory (DRAM), synchronous DRAM (SDRAM), read-only memory (ROM), or a combination thereof. In an embodiment, the memory 1008 may include ROM for use at boot-up, and DRAM for program and data storage for use while executing programs.

The mass storage 1004 may comprise any type of non-transitory storage device configured to store data, programs, and other information and to make the data, programs, and other information accessible via the bus 1020. The mass storage 1004 may comprise, for example, one or more of a solid state drive, hard disk drive, a magnetic disk drive, or an optical disk drive.

The video adapter 1010 and the I/O interface 1012 provide interfaces to couple external input and output devices to the processing unit 1002. As illustrated, examples of input and output devices include a display 1018 coupled to the video adapter 1010 and a mouse, keyboard, or printer 1016 coupled to the I/O interface 1012. Other devices may be coupled to the processing unit 1002, and additional or fewer interface cards may be utilized. For example, a serial interface such as Universal Serial Bus (USB) (not shown) may be used to provide an interface for an external device.

The processing unit 1002 also includes one or more network interfaces 1006, which may comprise wired links, such as an Ethernet cable, or wireless links to access nodes or different networks. The network interfaces 1006 allow the processing unit 1002 to communicate with remote units via the networks. For example, the network interfaces 1006 may provide wireless communication via one or more transmitters/transmit antennas and one or more receivers/receive antennas. In an embodiment, the processing unit 1002 is coupled to a local-area network 1022 or a wide-area network for data processing and communications with remote devices, such as other processing units, the Internet, or remote storage facilities.

It should be appreciated that one or more steps of the embodiment methods provided herein may be performed by corresponding units or modules. For example, a signal may be transmitted by a transmitting unit or a transmitting module. A signal may be received by a receiving unit or a receiving module. A signal may be processed by a processing unit or a processing module. Other steps may be performed by a performing unit or module, a generating unit or module, an obtaining unit or module, a setting unit or module, an adjusting unit or module, an increasing unit or module, a decreasing unit or module, a determining unit or module, a modifying unit or module, a reducing unit or module, a removing unit or module, or a selecting unit or module. The respective units or modules may be hardware, software, or a combination thereof. For instance, one or more of the units or modules may be an integrated circuit, such as field programmable gate arrays (FPGAs) or application-specific integrated circuits (ASICs).

Although the present disclosure and its advantages have been described in detail, it should be understood that various changes, substitutions and alterations can be made herein without departing from the scope of this disclosure.

What is claimed:

1. A method, comprising:
sending, by a first network entity of a wireless core network to a network data analytics function (NWDAF) entity, a request for enhanced analytics output parameters associated with a redundant transmission;
receiving, by the first network entity from the NWDAF entity, the enhanced analytics output parameters; and
determining, by the first network entity, a mechanism for the redundant transmission based on the enhanced analytics output parameters.

2. The method of claim 1, the first network entity including at least one of a policy control function (PCF) entity or a session management function (SMF) entity.

3. The method of claim 1, the determining the mechanism comprising:
determining, by the first network entity, whether to activate or deactivate the redundant transmission based on the enhanced analytics output parameters.

4. The method of claim 3, the determining the mechanism comprising:
after determining to activate the redundant transmission, determining, by the first network entity, whether to update a user equipment (UE) Route Selection Policy (URSP) rule for the redundant transmission based on the enhanced analytics output parameters.

5. The method of claim 4, the determining the mechanism comprising:
after determining to update the URSP rule, updating, by the first network entity, URSP rule information for the redundant transmission; and
sending, by the first network entity to a URSP rule policy making entity, the URSP rule information.

6. The method of claim 5, the URSP rule policy making entity including a policy control function (PCF) entity.

7. The method of claim 1, wherein the enhanced analytics output parameters are for each path of a primary path and a secondary path of the redundant transmission.

8. The method of claim 1, wherein the enhanced analytics output parameters are for each link of links for the redundant transmission, and wherein the links for the redundant transmission include at least one radio access network (RAN) link and at least one N3 link.

9. The method of claim 1, the enhanced analytics output parameters being based on enhanced analytics input parameters, the enhanced analytics input parameters including a RAN uplink (UL) or downlink (DL) packet delay.

10. The method of claim 1, the enhanced analytics output parameters including at least one of a predicted primary or secondary RAN path redundant transmission experience between a UE and a master or a secondary next generation (NG)-RAN, a predicted primary or secondary N3 tunnel path redundant transmission experience from an NG-RAN to a user plane function (UPF) entity, or a list of one or more master or secondary NG-RAN nodes.

11. A method, comprising:
receiving, by a network data analytics function (NWDAF) entity from a first network entity of a wireless core network, a request for enhanced analytics output parameters associated with a redundant transmission;
collecting, by the NWDAF entity, enhanced analytics input parameters associated with the redundant transmission; and
sending, by the NWDAF entity to the first network entity, the enhanced analytics output parameters.

12. The method of claim 11, the collecting comprising:
collecting, by the NWDAF entity, the enhanced analytics input parameters from at least one of a policy control function (PCF) entity, a session management function (SMF) entity, a user plane function (UPF) entity, an operations, administration, and management (OAM) entity, or an access and mobility management function (AMF) entity.

13. The method of claim 11, the first network entity including at least one of a policy control function (PCF) entity or a session management function (SMF) entity.

14. The method of claim 11, wherein the enhanced analytics output parameters are for each path of a primary path and a secondary path of the redundant transmission.

15. The method of claim 11, wherein the enhanced analytics output parameters are for each link of links for the redundant transmission, and wherein the links for the redundant transmission include at least one radio access network (RAN) link and at least one N3 link.

16. The method of claim 11, further comprising:
determining, by the NWDAF entity, the enhanced analytics output parameters based on enhanced analytics input parameters.

17. The method of claim 16, the enhanced analytics input parameters including a RAN uplink (UL) or downlink (DL) packet delay.

18. The method of claim 11, the enhanced analytics output parameters including at least one of a predicted primary or secondary RAN path redundant transmission experience between a UE and a master or a secondary next generation (NG)-RAN, a predicted primary or secondary N3 tunnel path redundant transmission experience from an NG-RAN to a user plane function (UPF) entity, or a list of one or more master or secondary NG-RAN nodes.

19. A network entity, comprising:
at least one processor; and
a non-transitory computer readable storage medium storing programming, the programming including instructions that, when executed by the at least one processor, cause the network entity to perform operations including:
sending, to a network data analytics function (NWDAF) entity, a request for enhanced analytics output parameters associated with a redundant transmission;
receiving, from the NWDAF entity, the enhanced analytics output parameters; and
determining a mechanism for the redundant transmission based on the enhanced analytics output parameters.

20. A network data analytics function (NWDAF) entity, comprising:
at least one processor; and
a non-transitory computer readable storage medium storing programming, the programming including instructions that, when executed by the at least one processor, cause the NWDAF entity to perform operations including:
receiving, from a first network entity of a wireless core network, a request for enhanced analytics output parameters associated with a redundant transmission;
collecting enhanced analytics input parameters associated with the redundant transmission; and
sending, to the first network entity, the enhanced analytics output parameters.
